(19) United States
(12) Patent Application Publication
(10) Pub. No.: US 2007/0264537 A1
(43) Pub. Date: Nov. 15, 2007

(54) FUEL CELL DEVICE WITH REMOTE CONTROL INTERFACE

(76) Inventors: Wei-Li Huang, Taipei (TW); Yu-Chin Wang, Taipei (TW)

Correspondence Address: G. LINK CO., LTD., 3550 BELL ROAD, MINOOKA, IL, 60447, US

(21) Appl. No.: 11/382,611

(22) Filed: May 10, 2006

(51) Int. Cl. H01M 8/04

(52) U.S. Cl. 429/12; 429/38; 429/22; 429/24

(57) ABSTRACT

A fuel cell device with a remote control interface comprises at least a fuel cell module and a communication module. Each fuel cell module performs electrochemical reactions and outputs power. The fuel cell module is composed of a plurality of stacked printed circuit substrates and at least a membrane electrode assembly disposed within the printed circuit substrates. The communication module includes a communication protocol for I/O messages. A remote device controls the operation of the fuel cell device through the communication module.

### FIELD OF THE INVENTION

The present invention relates to a fuel cell device, and more particularly, to a fuel cell device having a remote control interface, and thus a remote device can monitor the operation of the fuel cell device and can communicate with the operated fuel cell device through a communication module.

### BACKGROUND OF THE INVENTION

Conventional fuel cells usually use redox of hydrogen-containing fuel like methanol to generate current loops and power. Such fuel cells require reactants including liquid fuel, such as methanol, and produce products including water and carbon dioxide after performing reactions. It is essential for this kind of fuel cell to utilize a container for containing liquid fuel and a flow structure for flowing fuel.

In one respect, the fuel supply of fuel cells and the control over operational temperatures have great influence on the performance of the fuel cells. Hence, an assistant device is needed to provide fuel for fuel cells and to control operational temperatures. Simple integration with fuel cells is still another characteristic of the assistant device.

With respect to systematized fuel cells and maintenance serviced by suppliers, a communication interface associating fuel cells with remote devices is also needed to monitor or control the operation of fuel cells remotely, or to upgrade controlling programs for fuel cells.

Therefore, an improved fuel cell device with a remote control interface is provided in the application to complete conventional fuel cells.

### SUMMARY OF THE INVENTION

It is a primary object of the invention to provide a fuel cell device with a remote control interface, which has the ability of communicating so that a remote device can control the operation of the fuel cell device.

It is another object of the invention to provide a fuel cell device with a remote control interface, which includes sensors and a radiator controlled by a remote device.

It is still another object of the invention to provide a fuel cell device with a remote control interface, which includes a fuel supply module controlled by a remote device.

In accordance with the aforesaid objects of the invention, a fuel cell device with a remote control interface is provided, which comprises at least a fuel cell module for performing electrochemical reactions and outputting power; wherein each fuel cell module is composed of a plurality of stacked printed circuit substrates and at least a membrane electrode assembly disposed on the substrates. The device also comprises a communication module having a communication protocol for messaging and inputting/outputting messages; wherein the fuel cell modules are electrically coupled to the communication module, and a remote device associated with the communication module controls the operation of the fuel cell device remotely.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a diagram showing a fuel cell device with a remote control interface according to the first embodiment of the invention;

FIG. 2 is a diagram showing a fuel cell device with a remote control interface according to the second embodiment of the invention; and

FIG. 3 is an elevational view showing a fuel cell device with a remote control interface according to the third embodiment of the invention.

### DETAILED DESCRIPTION OF THE INVENTION

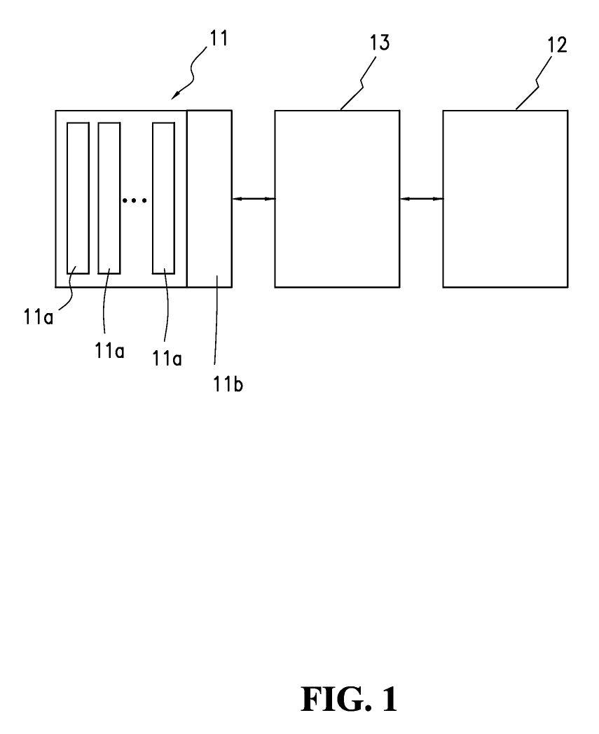

FIG. 1 is a diagram showing a fuel cell device with a remote control interface according to the first embodiment of the invention. A fuel cell device 11 with a remote control interface comprises fuel cell modules 11a in communication with a remote device 12. Each module 11a is a power generator composed of printed circuit substrates which are stacked and membrane electrode assemblies (MEAs). For example, the module 11a is a conventional direct methanol fuel cell (DMFC), of which substrates may be multi-layers of FR4, epoxy glass fiber substrates, ceramic substrates, polymer plastic substrates, or composite substrates, and pluralities of MEAs are sandwiched within the stacked substrates to perform electrochemical reactions and to output power.

Referring to FIG. 1, the fuel cell device 11 includes a plurality of fuel cell modules 11a and a communication module 11b. The modules 11a are electrically coupled to the communication module 11b. The communication module 11b is a message input/output (I/O) device that transfers communication protocols; wherein the communication protocols can be transferred by a network communication means. An exemplar of network communication means may be an Ethernet network, a coaxial cable network, a wireless network, or a mobile network.

The communication module 11b of the fuel cell device 11 and the remote device are linked together through a transmission device 13. For example, if the communication module 11b uses an Ethernet network to transfer its communication protocols, an end of the transmission device 13 includes an Ethernet interface and the other end of the transmission device 13 includes an Internet interface. As such, the fuel cell device 11 communicates with the remote device 12 by means of the communication module 11b and the transmission device 13. So the fuel cell device 11 and the remote device 12 can transfer and interchange data with each other.

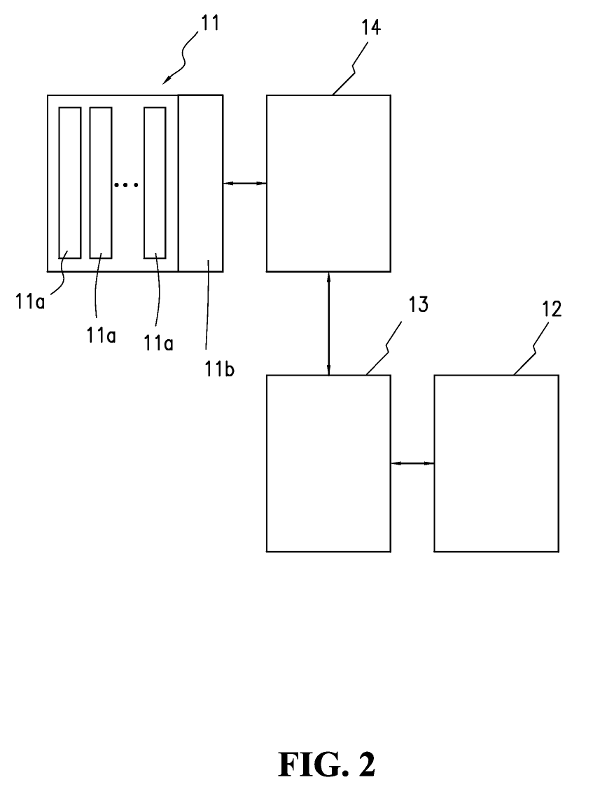

FIG. 2 is a diagram showing a fuel cell device with a remote control interface according to the second embodiment of the invention. A fuel cell device 11 with a remote control interface comprises fuel cell modules 11a in communication with a remote device 12. The communication module 11b may include a communicating means for peripherals, such as universal serial bus (USB), IEEE 1394, SDIO, Bluetooth, RS-232, RU-486, infrared transmission, RF communication, and etc.

The fuel cell device 11 is in communication with a computer 14 through the communication module 11b, and the computer 14 is electrically connected to a remote device 12 by a transmission device 13. The computer 14 also includes a communicating means consistent with the communication module 11b and the transmission device 13 such that the fuel cell device 11, the communication module 11b, the computer 14, the transmission device 13, and the remote device 12 are linked together to be a communicating chain. For example, the communication module 11b may communicate outside using the USB means, and connects with the USB port of the computer 14 through a USB transmission line. The transmission device 13 may include an Ethernet interface at one end, which is coupled to the Ethernet card of the computer 14, and another end of the transmission device 13 may be in communication with the remote device 12. Accordingly, the remote device 12 and the fuel cell device 11 transfer and interchange data with each other.

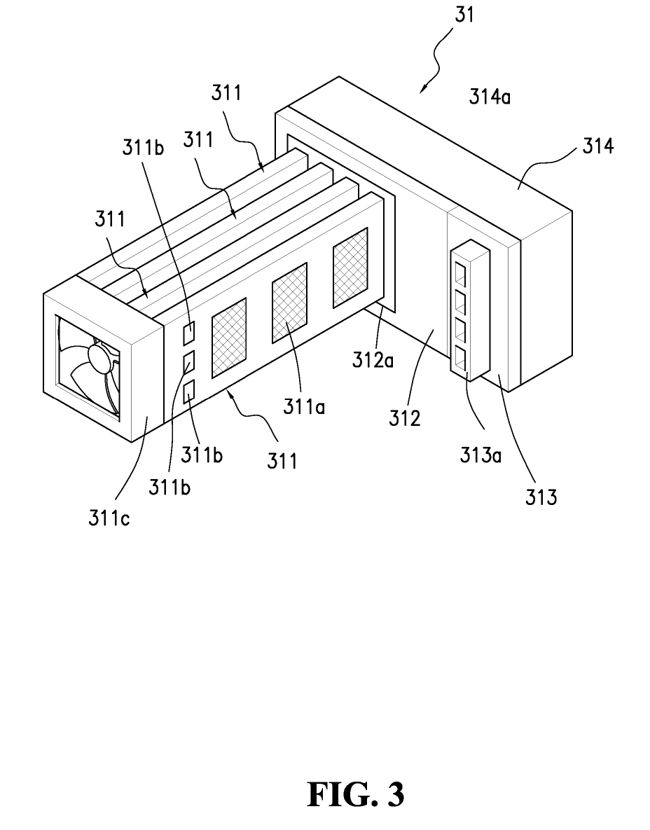

FIG. 3 is an elevational view showing a fuel cell device with a remote control interface according to the third embodiment of the invention. A fuel cell device 31 with a remote control interface comprises fuel cell modules 311, a first circuit board 312, a second circuit board 313, and a fuel supply module 314. The cell module 311 is a power generator composed of printed circuit substrates which are stacked and MEAs 311a. The MEAs 311a perform electrochemical reactions and output electricity. The first circuit board 312 is a sheet of printed circuit substrate with a plurality of first connectors 312a. The first connectors 312a are provided to connect the modules 311. The modules 311 are fixed and coupled onto the first circuit board 312 by using the corresponding first connectors 312a. The second circuit board 313 is electrically connected with the first circuit board 312, and a second connector 313a is disposed on the second circuit board 313 for external connection. The second connector 313a is provided to transmit signals of communication protocols. The fuel supply module 314 includes components to supply fuel, which delivers fuel to a corresponding module 311 through each first connector 312a of the first circuit board 312.

Regarding to the fuel cell device 31, because the first circuit board 312 is electrically connected with the second circuit board 313, the message from each module 311 is sent out by the second connector 313a. A remote device 12 (not shown in FIG. 3) is associated with the fuel cell device 31, and monitors or controls the performance of the fuel cell device 31. The second circuit board 313 may utilize a communicating means, such as Ethernet network, coaxial cables network, wireless network, mobile network, USB, IEEE 1394, SDIO, Bluetooth, RS-232, RU-486, infrared transmission, RF communication, and so forth.

Referring to FIG. 3, the cell module 311 further includes at least one sensor 311b and a radiator 311c like a fan. The fuel supply module 314 also includes at least one pump (not shown in FIG. 3) and/or at least one valve (not shown in FIG. 3). The sensors 311b include a temperature sensor, a concentration sensor, a current sensor, and a voltage sensor for detecting various physical properties of the module 311. The electrical signals from the sensors 311b are transferred to the remote device 12 through the first circuit board 312 and the second circuit board 313. The fan 311c produces air flow fields, so as to cool the modules 311 down and to provide sufficient content of oxygen. The remote device 12 transmits control messages to the first circuit board 312, and then controls the fan 311c remotely. Meanwhile, status messages of the fan 311c are fed back to the remote device 12 for next progress of remote controlling. The pumps and/or the valves are provided to drive fuel inside the fuel supply module 314 flowing to the modules 311 through the first connectors 312a. In addition, the remote device 12 transmits control messages to the first circuit board 312, and then remotely controls the pumps and/or the valves. Status messages of the fan 311c are also fed back to the remote device 12 for next progress of remote controlling.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel cell device with a remote control interface, comprising:
at least one fuel cell module for performing electrochemical reactions and outputting power, wherein each fuel cell module includes a plurality of stacked printed circuit substrates, and at least one membrane electrode assembly is disposed on the printed circuit substrates; and
a communication module having a communication protocol for messaging and inputting/outputting messages;
wherein all the fuel cell modules are electrically coupled to the communication module, and a remote device is in remote communication with the communication module for controlling an operation of the fuel cell device from afar.

2. The fuel cell device with the remote control interface of claim 1, wherein the communication module is a network communicating means, wherein the network communicating means is selected from a group consisting of Ethernet communicating means, coaxial cable communicating means, wireless network communicating means, and mobile network communicating means.

3. The fuel cell device with the remote control interface of claim 1, wherein the communication module comprises using a communicating means for peripherals, wherein the communicating means is selected from a group consisting of USB, IEEE 1394, SDIO, Bluetooth, RS-232, RU-486, infrared transmission, and RF communication.

4. The fuel cell device with the remote control interface of claim 1, wherein the fuel cell device is linked with a transmission device and the remote device through the communication module, so as to form a communicating chain.

5. The fuel cell device with the remote control interface of claim 4, wherein the fuel cell device is linked with a computer, a transmission device and the remote device through the communication module, so as to form a communicating chain.

6. The fuel cell device with the remote control interface of claim 1, wherein the fuel cell module is a liquid fuel cell.

7. The fuel cell device with the remote control interface of claim 1, wherein the fuel cell module is a gaseous fuel cell.

8. The fuel cell device with the remote control interface of claim 1, wherein the fuel cell module is a solid fuel cell.

9. The fuel cell device with the remote control interface of claim 1, wherein the printed circuit substrate is selected from a group consisting of an FR4 substrate, an epoxy glass fiber substrate, a ceramic substrate, a polymer plastic substrate, and a composite substrate.

10. The fuel cell device with the remote control interface of claim 1, wherein the fuel cell device further comprises:
a first circuit board made of a sheet of printed circuit substrate having at least one first connector, wherein the first connectors are connected to the corresponding fuel cell modules, and thereby the cell modules are fixed and electrically connected onto the first circuit board through said corresponding first connectors;
a second circuit board made of a sheet of printed circuit substrate having the communication module and a second connector, wherein the second connector transmits a message from the communication protocol; and
a fuel supply module is a fuel supply device of a fuel cell, and provides fuel for a corresponding fuel cell module by each first connector of the first circuit board.

11. The fuel cell device with the remote control interface of claim 10, wherein the fuel cell module further comprises at least one sensor.

12. The fuel cell device with the remote control interface of claim 11, wherein the sensor is a temperature sensor and/or a concentration sensor and/or a current sensor and/or a voltage sensor, and a detected signal from the sensor is transmitted to the remote device.

13. The fuel cell device with the remote control interface of claim 10, wherein the fuel cell module further comprises a radiator controlled by the remote device.

14. The fuel cell device with the remote control interface of claim 13, wherein the radiator is a fan or an air pump.

15. The fuel cell device with the remote control interface of claim 10, wherein the fuel supply module comprises at least one pump and/or at least one valve for driving fuel flowing to the fuel cell modules.
